(19) United States
(12) Patent Application Publication
(10) Pub. No.: US 2019/0139160 A1
(43) Pub. Date: May 9, 2019

(54) FEE SETTING DEVICE AND FEE SETTING METHOD

(71) Applicant: TOYOTA JIDOSHA KABUSHIKI KAISHA, Toyota-shi (JP)

(72) Inventors: Aya ONODERA, Nisshin-shi (JP); Akihiko NAKANISHI, Nisshin-shi (JP); Takumi HAMAJIMA, Osaka-shi (JP); Yusuke TSUTSUI, Gifu-ken (JP)

(73) Assignee: TOYOTA JIDOSHA KABUSHIKI KAISHA, Toyota-shi (JP)

(21) Appl. No.: 16/180,667

(22) Filed: Nov. 5, 2018

(30) Foreign Application Priority Data
Nov. 7, 2017 (JP) 2017-214874

(51) Int. Cl. G06Q 50/06; G06Q 50/30; G06Q 30/02

(52) U.S. Cl. CPC G06Q 50/06; G06Q 30/0283; G06Q 50/30

(57) ABSTRACT

A fee setting device obtains reservation information from a management device, such as a scheduled departure time input by a user via a communication terminal in order to make a reservation of a vehicle and determines whether there is a recommended vehicle at the scheduled departure time. If there is a recommended vehicle the fee setting device recommends the vehicle via the communication terminal. If the user selects the recommended vehicle and the vehicle is returned with an SOC falling within a recommended range, the fee setting device sets a utilization fee of a lower price than a reference fee.

This nonprovisional application is based on Japanese Patent Application No. 2017-214874 filed on Nov. 7, 2017 with the Japan Patent Office, the entire contents of which are hereby incorporated by reference.

### BACKGROUND

### Field

The present disclosure relates to setting a car sharing fee for an electric vehicle traveling using power stored in a power storage device.

### Description of the Background Art

Car sharing allowing a plurality of users to share a single vehicle is increasingly utilized. Car sharing means that a user himself/herself does not own a vehicle and instead obtains membership of a car sharing business operation and appropriately utilizes a vehicle owned by the business operator. In recent years, as electric vehicles are increasingly used, the vehicles are also increasingly used in car sharing.

Accordingly, to promote electric vehicle car sharing (hereinafter also referred to as “EV car sharing”), a proposal has been made for setting a utilization fee for EV car sharing.

For example, Japanese Patent Laying-Open No. 2013-232129 discloses a fee setting device which sets an EV car sharing utilization fee depending on a state of charge (hereinafter also referred to as “SOC”) which a power storage device of a vehicle has when the vehicle is rented out or returned.

### SUMMARY

Generally, a secondary battery included in a power storage device mounted in an electric vehicle degrades in different degrees depending on how it is used. For example, a secondary battery rapidly degrades when the amount of power stored therein continues to be in a high charge capacity state exceeding a predetermined range or the secondary battery is used so that the amount of power stored therein is reduced to a low charge capacity state equal to or less than the predetermined range.

Accordingly, in EV car sharing, it is desired to use an electric vehicle (hereinafter, also simply referred to as a “vehicle”) in such a manner that the vehicle has a power storage device charged/discharged such that the power storage device has stored therein an amount of power falling within a predetermined range.

The fee setting device disclosed in Japanese Patent Laying-Open No. 2013-232129 encourages a user to use a vehicle within a predetermined SOC range by reducing a utilization fee of EV car sharing when a vehicle has an SOC within a predetermined SOC range when the vehicle is rented or returned.

In general, however, the distance which an electric vehicle can cruise is shorter than that which a gasoline-powered vehicle driven by an internal combustion engine to travel travels. As such, in EV car sharing, not a few users wish to rent an electrically fully or substantially fully charged vehicle even when the user travels a relatively short distance.

Accordingly, in addition to the fee setting mechanism which promotes utilization of a vehicle within a predetermined SOC range as described in Japanese Patent Laying-Open No. 2013-232129, there is a need for a means for further promoting utilization of a vehicle within a predetermined SOC range.

The present disclosure has been made to solve the above-described problem, and it is an object thereof to encourage a user of car sharing of an electric vehicle who desires to rent an electrically substantially fully charged vehicle to utilize a vehicle having stored therein an amount of power falling within a predetermined range.

A fee setting device according to the present disclosure is configured to set a utilization fee for sharing an electric vehicle. The fee setting device comprises: an information acquisition unit configured to obtain, from a vehicle utilized for the sharing, information of an amount of power stored in a power storage device mounted in the vehicle; a vehicle setting unit configured to set as a recommended vehicle a vehicle with a power storage device having an amount of power stored therein within a predetermined range when the vehicle is rented, and recommend the vehicle to a user; and a fee setting unit configured to set the utilization fee. The amount of power stored in the power storage device when the vehicle is rented is estimated from the amount of power stored in the power storage device that is obtained by the information acquisition unit. The fee setting unit is configured to set the utilization fee at a lower price than a reference fee of the utilization fee when the recommended vehicle is utilized and an end amount of power falls within the predetermined range, the end amount of power being an amount of power stored in the power storage device when the vehicle is returned.

A fee setting method according to the present disclosure is configured to set a utilization fee for sharing an electric vehicle. The present fee setting method comprises: obtaining, from a vehicle used for the sharing, information of an amount of power stored in a power storage device mounted in the vehicle; setting as a recommended vehicle a vehicle with a power storage device having an amount of power stored therein within a predetermined range when the vehicle is rented, and recommending the vehicle to a user; setting the utilization fee; and estimating the amount of power stored in the power storage device when the vehicle is rented from the obtained amount of power stored in the power storage device. The step of setting the utilization fee includes setting the utilization fee at a lower price than a reference fee of the utilization fee when the recommended vehicle is utilized and an end amount of power falls within the predetermined range, the end amount of power being an amount of power stored in the power storage device when the vehicle is returned.

According to the above configuration, the fee setting device sets as a recommended vehicle a vehicle with a power storage device having stored therein an amount of power falling within a predetermined range, and recommends the vehicle to a user. This allows the user to recognize the recommended vehicle and can increase the possibility that the recommended vehicle may be utilized. When the recommended vehicle is utilized, and an end amount of power stored therein when utilizing the vehicle ends (or the vehicle is returned) is within the predetermined range, a utilization fee of a lower price than the reference fee is set, which promotes utilization such that the end amount of power falls within the predetermined range. When the recommended vehicle is returned with an amount of power stored therein within the predetermined range, it is inferred that the recommended vehicle while in use has also been utilized within the predetermined range. That is, utilization of the vehicle within the recommended range is promoted. For example, by setting the predetermined range to a range which does not accelerate degradation of the power storage device of the vehicle, utilization with suppression of degradation of the power storage device can be promoted.

Preferably, the fee setting unit sets the reference fee as the utilization fee when the recommended vehicle is utilized and the end amount of power is outside the predetermined range.

According to the above configuration, when the recommended vehicle is returned with an end amount of power falling within the predetermined range stored therein, an economical advantage can be obtained, which promotes returning the recommended vehicle with an end amount of power falling within the predetermined range stored therein. That is, utilization of the vehicle within the recommended range is promoted.

Preferably, the fee setting unit sets the utilization fee at a lower price than the reference fee when the recommended vehicle is utilized and the end amount of power stored in the power storage device of the recommended vehicle falls within the predetermined range and is also equal to or larger than a reference value within the predetermined range.

According to the above configuration, returning the vehicle with an amount of power equal to or larger than the reference value stored therein is promoted. The vehicle returned with an amount of power equal to or larger than the reference value stored therein can be immediately available to a next user, which enhances efficiency of utilization of EV car sharing.

Preferably, the fee setting unit sets the utilization fee at a higher price than the reference fee when a vehicle with a power storage device having stored therein an amount of power larger than the recommended vehicle is selected.

According to the above configuration, selecting a vehicle with a power storage device having stored therein an amount of power larger than a recommended vehicle, is suppressed. This promotes utilization of the recommended vehicle.

Preferably, the utilization fee includes a fixed-fee portion in which a fee per unit period of time is fixed, and a metered-fee portion in which a fee varies with an amount of power used as the vehicle is utilized. The fee setting unit sets the fixed-fee portion at a lower price when a recommended plan is applied than when the recommended plan is not applied, the recommended plan setting a unit price of power of the metered-fee portion based on the amount of power stored in the power storage device.

According to the above configuration, by applying the recommended plan, a fixed-fee portion of a lower price is set, which promotes utilization of the recommended plan. In the recommended plan, a unit price of power of a metered-fee portion is set based on an amount of power stored in the power storage device of the vehicle, which promotes utilization of the vehicle within a predetermined range.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing an overall configuration of a sharing system according to a first embodiment.

FIG. 2 is a diagram showing an example of a detailed configuration for charging an electric vehicle according to the first embodiment.

FIG. 3 is a functional block diagram showing a configuration of a controller of a fee setting device according to the first embodiment.

FIG. 4 is a diagram showing an example of a configuration of a vehicle information list stored in the fee setting device according to the first embodiment.

FIG. 5 is a diagram showing an example of a display list displayed by a communication terminal according to the first embodiment.

FIG. 6 is a diagram showing an example of a configuration of a fee list stored in the fee setting device according to the first embodiment.

FIG. 7 is a diagram showing an example of a configuration of a user list stored in the fee setting device according to the first embodiment.

FIG. 8 is a flowchart showing a process performed by the fee setting device according to the first embodiment.

FIG. 9 is a flowchart showing a process performed by the fee setting device according to the first embodiment for regular utilization.

FIG. 10 is a flowchart showing a process performed by the fee setting device according to the first embodiment for recommended utilization.

FIG. 11 is a diagram showing an example of a configuration of a fee list stored in the fee setting device according to a second embodiment.

FIG. 12 is a diagram showing an example of a configuration of a user list stored in the fee setting device according to the second embodiment.

FIG. 13 is a flowchart showing a process performed by the fee setting device according to the second embodiment for setting a fixed fee.

FIG. 14 is a flowchart showing a process performed by the fee setting device according to the second embodiment for setting a metered fee.

FIG. 15 is a flowchart showing a process performed by the fee setting device according to the second embodiment for non-recommended utilization.

FIG. 16 is a diagram for illustrating an example with the configuration of the second embodiment applied thereto.

### DESCRIPTION OF THE PREFERRED EMBODIMENTS

The present disclosure will now be described in embodiments hereinafter in detail with reference to the drawings. In the figures, identical or corresponding components are identically denoted and will not be described repeatedly.

### First Embodiment

Configuration of Sharing System

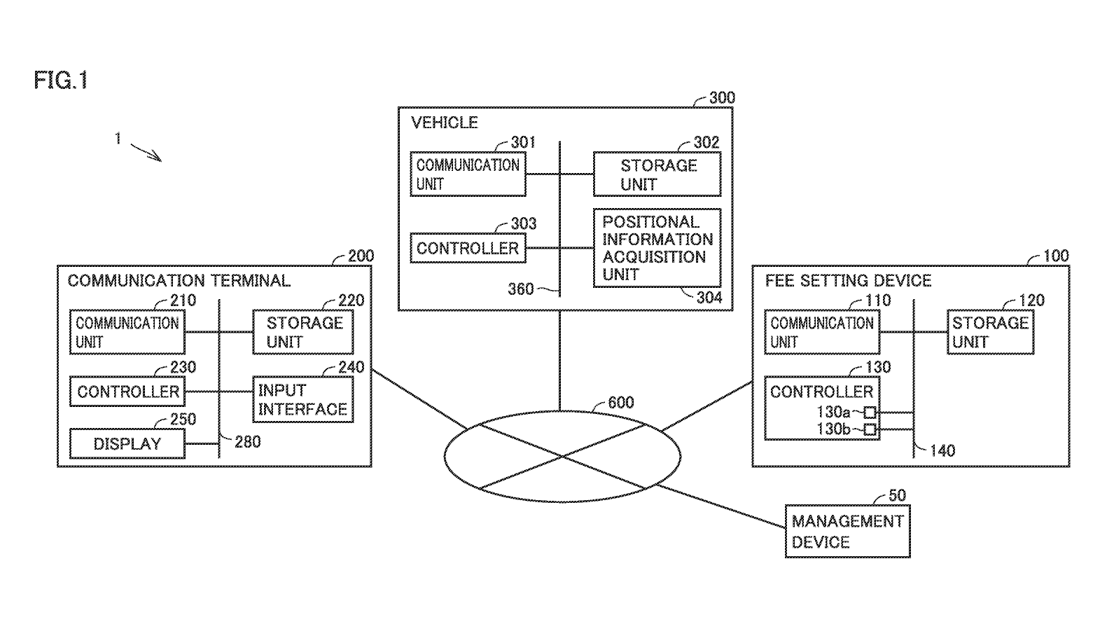

FIG. 1 is a diagram schematically showing an overall configuration of a sharing system 1 according to a first embodiment. As shown in FIG. 1, sharing system 1 according to the first embodiment includes a management device 50, a fee setting device 100, a communication terminal 200, and a vehicle 300 which is an electric vehicle. While FIG. 1 shows only a single vehicle 300, there may be a plurality of vehicles 300.

Management device 50 manages EV car sharing using sharing system 1. For example, management device 50 manages reservation of vehicles used for EV car sharing, statuses of vehicles, such as whether they are rented/returned, and so forth.

Communication terminal 200 is a communication terminal used by a user of sharing system 1 according to the first embodiment, and is, for example, a smartphone, a personal computer, or the like. Using communication terminal 200, the user communicates with management device 50 to perform membership registration for EV car sharing using sharing system 1, reserve a vehicle for EV car sharing, select a vehicle, and so forth. While in the first embodiment an example is indicated in which management device 50 and fee setting device 100 are discretely provided, management device 50 and fee setting device 100 may be a single device equipped with their functions.

Fee setting device 100 includes a communication unit 110, a storage unit 120, and a controller 130. Each component is communicatively connected by a communication bus 140.

Communication unit 110 is configured to be capable of communicating with a communication unit 210 of communication terminal 200, a communication unit 301 of vehicle 300, and management device 50, for example. Communications between communication unit 110, and communication units 210 and 301 and management device 50 are performed via a communication network 600 such as the Internet or a telephone line.

Storage unit 120 includes, for example, a large-capacity storage device such as a hard disk or a solid state drive. Storage unit 120 has stored therein information of users holding membership in EV car sharing. Further, storage unit 120 has stored therein a vehicle information list 500 having stored therein vehicles' information, SOC information, and the like. Further, storage unit 120 has stored therein a fee list 550 specifying a fee rate etc., and further, storage unit 120 has stored therein a user list 700 in which various pieces of information on each user's utilization of EV car sharing are registered. Vehicle information list 500, fee list 550 and user list 700 will more specifically be described hereinafter.

Controller 130 includes a CPU (central processing unit) 130a, a memory (ROM and RAM) 130b, an input/output port (not shown) for inputting/outputting various signals, and the like. Controller 130 is configured to execute predetermined computation processing based on information stored in storage unit 120, information received from communication terminal 200, vehicle 300 and/or the like via communication unit 110, and/or the like. Details of controller 130 will be described later.

Communication terminal 200 includes communication unit 210, storage unit 220, a controller 230, an input interface 240, and a display 250. Each component is communicatively connected by a communication bus 280.

Communication unit 210 is configured to allow communications with communication unit 110 of fee setting device 100, management device 50 and the like. Communications between communication unit 210, and communication unit 110, management device 50 and the like are performed via communication network 600.

Storage unit 220 includes, for example, a large-capacity storage device such as a flash memory, a hard disk, a solid state drive or the like.

Controller 230 is configured to execute predetermined computation processing based on information stored in storage unit 220 and information received from fee setting device 100 via communication unit 210, for example.

Input interface 240 is an input device in communication terminal 200. Input interface 240 is composed of a keyboard, a mouse, a touch panel, and the like, and accepts input operations done via the keyboard, the mouse, the touch panel, and the like.

Display 250 is a display device controlled by controller 230 to display an image. Display 250 is implemented for example as a liquid crystal panel or the like.

Vehicle 300 includes a communication unit 301, a storage unit 302, a controller 303, and a positional information acquisition unit 304. Each component is communicatively connected by a communication bus 360.

Communication unit 301 is configured to allow communications with communication unit 110 of fee setting device 100, management device 50 and the like. Communications between communication unit 301, and communication unit 110, management device 50 and the like are performed via communication network 600.

Storage unit 302 is, for example, a storage device including a nonvolatile memory, a hard disk, a solid state drive or the like. Storage unit 302 stores, for example, information of an SOC of a power storage device mounted in vehicle 300, information of the position of vehicle 300, and the like.

Controller 303 includes, for example, a CPU, memory (ROM and RAM), and an input/output port for inputting and outputting various signals, none of which is shown. Controller 303 is configured to execute predetermined computation processing based on information stored in storage unit 302.

Further, controller 303 monitors a state of the power storage device mounted in vehicle 300. For example, controller 303 senses the power storage device's voltage, current, and temperature, uses these values to estimate an OCV (Open Circuit Voltage), and calculates the power storage device's SOC. Further, controller 303 may calculate the SOC of the power storage device from an accumulation of amounts of power charged/discharged. The calculation of the SOC may be done using any well-known technique, and accordingly, will not be described specifically.

Further, for example, when vehicle 300 shifts from a READY-OFF state to a READY-ON state, controller 303 transmits via communication unit 301 to fee setting device 100 start-of-utilization information serving as notification that utilization of vehicle 300 starts, and together with that information, controller 303 also transmits via communication unit 301 to fee setting device 100 vehicle information serving as information for identifying vehicle 300. When vehicle 300 has shifted from the READY-ON state to the READY-OFF state, controller 303 transmits to fee setting device 100 end-of-utilization information serving as notification that utilization of vehicle 300 ends. Note that the READY-ON state refers to a state in which a vehicle is capable of traveling, and the READY-OFF state refers to a state in which a vehicle is incapable of traveling.

Positional information acquisition unit 304 is configured to obtain a current position of vehicle 300. For example, positional information acquisition unit 304 uses a GPS (Global Positioning System) to obtain the current position of vehicle 300. Positional information acquisition unit 304 transmits to controller 303 positional information indicating the obtained current position of vehicle 300.

Controller 303 causes storage unit 302 to store information of a calculated SOC, the positional information received from positional information acquisition unit 304 and the like. While vehicle 300 is in the READY-ON state and the power storage device is being charged, controller 303 periodically transmits to fee setting device 100 the information of the calculated SOC and the positional information obtained by positional information acquisition unit 304. Further, in response to a request from fee setting device 100, controller 303 transmits vehicle 300's SOC information and positional information to fee setting device 100 via communication unit 301. Further, when vehicle 300 shifts from the READY-ON state to the READY-OFF state, controller 303 transmits vehicle 300's SOC information and positional information to fee setting device 100 via communication unit 301.

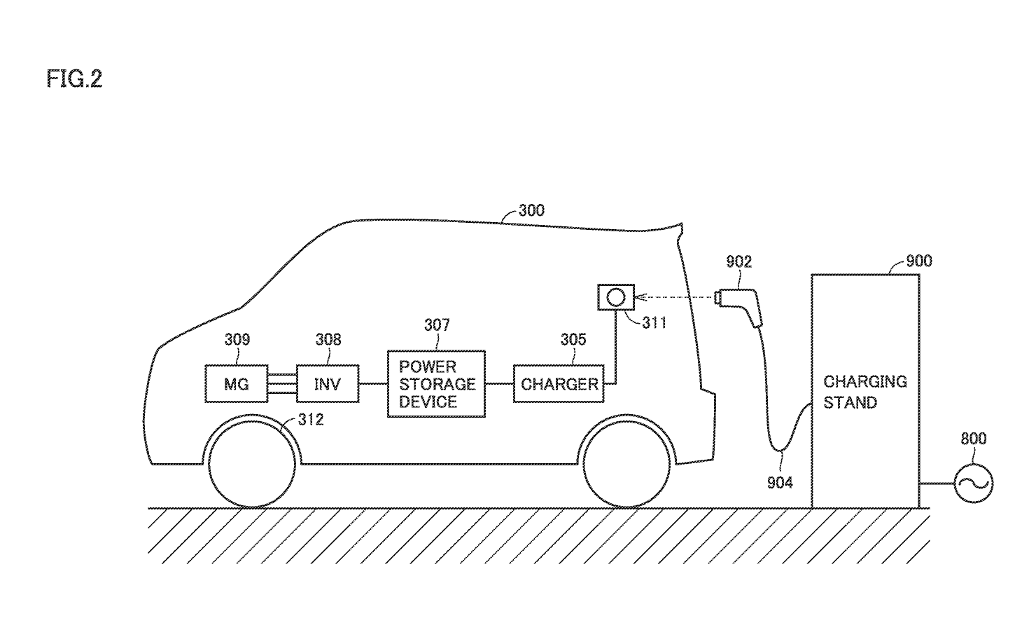

FIG. 2 is a diagram showing an example of a detailed configuration for charging an electric vehicle according to the first embodiment. FIG. 2 does not show communication unit 301, controller 303, and the like shown in FIG. 1.

As shown in FIG. 2, vehicle 300 further includes a charger 305, a power storage device 307, an inverter 308, a motor generator 309, and an inlet 311.

When a charging stand 900 has a charging connector 902 attached to inlet 311, charger 305 charges power storage device 307 with power supplied from an external power source 800.

Power storage device 307 is configured using, for example, a secondary battery such as a nickel metal hydride battery or a lithium ion battery. Power storage device 307 may be any power storage device capable of storing power, and for example, a large-capacity capacitor may be used instead of power storage device 307.

Inverter 308 is a power conversion device which converts power between AC power and DC power. Inverter 308, for example, converts DC power of power storage device 307 into AC power and supplies it to motor generator 309. Further, inverter 308 receives AC power (regenerative power) from motor generator 309, converts it into DC power, and supplies it to power storage device 307 to electrically charge power storage device 307 therewith.

Motor generator 309 receives power supplied from inverter 308 and provides rotational force to a drive wheel 312. Drive wheel 312 is rotated by the rotational force provided by motor generator 309 to drive vehicle 300.

Inlet 311 is provided to vehicle 300 at an exterior portion of vehicle 300 together with a cover (not shown) such as a lid. Inlet 311 has a shape allowing charging connector 902 to be attached thereto. Inlet 311 and charging connector 902 both have contacts, respectively, built therein, and when charging connector 902 is attached to inlet 311, the contacts come into contact with each other, and inlet 311 and charging connector 902 are thus electrically connected together.

Charging stand 900 is installed outside vehicle 300 and connected to charging connector 902 via charging cable 904. Charging stand 900 is electrically connected to power source 800, and when charging connector 902 is attached to inlet 311, the power of power source 800 is supplied via charging stand 900, charging cable 904, and charging connector 902 to vehicle 300.

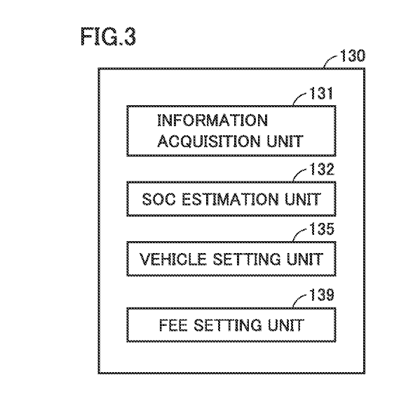

FIG. 3 is a functional block diagram showing a configuration of controller 130 of fee setting device 100 according to the first embodiment. Controller 130 includes an information acquisition unit 131, an SOC estimation unit 132, a vehicle setting unit 135, and a fee setting unit 139.

Information acquisition unit 131 obtains start-of-utilization information, end-of-utilization information, vehicle information, SOC information, positional information, and the like from vehicle 300 via communication unit 110. Furthermore, information acquisition unit 131 requests via communication unit 110 vehicle 300's SOC information and positional information from vehicle 300. Note that obtaining the start-of-utilization information and the end-of-utilization information is not limited to doing so from vehicle 300; for example, if management device 50 manages the start-of-utilization information and end-of-utilization information of vehicle 300, they may be obtained from management device 50. Furthermore, information acquisition unit 131 obtains from management device 50 information on a user, such as a user ID, reservation information for vehicle 300 input via communication terminal 200, and the like.

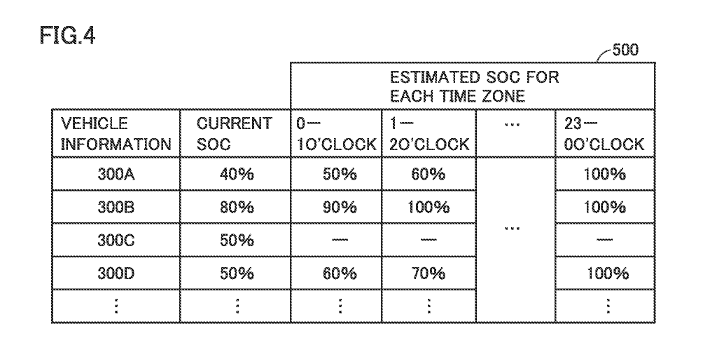

SOC estimation unit 132 calculates an SOC of vehicle 300 estimated for each of a plurality of predetermined time zones for vehicle 300 that is returned and charged (hereinafter also referred to as an “estimated SOC”). Details will be described with reference to FIG. 4.

Vehicle setting unit 135 obtains an estimated SOC of each vehicle for a user's scheduled departure time with reference to vehicle information list 500, which will be described hereinafter. Vehicle setting unit 135 sets as a recommended vehicle a vehicle whose estimated SOC obtained is within a recommended range at the user's scheduled departure time. Vehicle setting unit 135 transmits the set, recommended vehicle's information to communication terminal 200 via communication unit 110.

The recommended range is a range of an amount of power stored in a power storage device that allows the power storage device to be used while suppressing degradation of a secondary battery included in the power storage device. In the first embodiment, the recommended range is determined using SOC. The recommended range can vary depending on the type of the secondary battery. Accordingly, it may be set depending on the type of the secondary battery, as appropriate. The recommended range corresponds in the present disclosure to a “predetermined range.”

Fee setting unit 139 sets an EV car sharing utilization fee charged to a user who utilizes vehicle 300. Fee setting unit 139 sets a fixed fee and a metered fee, which will be described later, in a method described later. Fee setting unit 139 also sets an EV car sharing utilization fee based on an SOC that vehicle 300 has when a user rents or returns vehicle 300 or the like.

EV Car Sharing

In the first embodiment, when a user uses communication terminal 200 to input a scheduled departure time or the like to make a reservation of vehicle 300, display 250 of communication terminal 200 displays a reservable vehicle (a display list 270 of the communication terminal described later). When reservation information such as a scheduled departure time or the like is obtained, fee setting device 100 determines whether there is a vehicle whose estimated SOC is within the recommended range at the scheduled departure time (hereinafter also referred to as a “recommended vehicle”). When a recommended vehicle can be prepared, information of the reservable vehicle, and together therewith, information indicating on display list 270 that it is a recommended vehicle are transmitted to communication terminal 200.

This allows the user to recognize the recommended vehicle and can increase the possibility that the recommended vehicle is selected.

For the EV car sharing in the first embodiment, a user registered as a user of EV car sharing is charged for each unit period of time a utilization fee charged for that unit period of time. A fixed fee and a metered fee are set for the utilization fee. The fixed fee is a fee incurred at a fixed price for each unit period of time for a user once the user has obtained membership of the EV car sharing. The fixed fee varies for every predetermined period of time composed of a plurality of unit periods of time. The metered fee is a fee incurred depending on an amount of power used as a user actually utilizes vehicle 300 for a unit period of time. In the first embodiment, the metered fee is a fee of using a vehicle in a metering system depending on an amount of power used. For example, the metered fee is calculated from a product of an amount of power used and a unit price of power. The unit price of power is set, as desired, by an EV car sharing business operator, depending on a fee of power of a commercial power supply, for example.

The fixed fee corresponds to a “fixed-fee portion” according to the present disclosure. The metered fee corresponds to a “metered-fee portion” according to the present disclosure. Furthermore, in the first embodiment, an example in which a unit price of power is set as a metered fee rate will be described. That is, a metered fee is calculated from a product of an amount of power used and a metered fee rate. A metered fee is not limited to a fee of using a vehicle that is incurred depending on an amount of power used, and may be, for example, a fee of using a vehicle that is incurred depending on a utilization time, a distance travelled, and so forth. Further, the unit period of time is, for example, half a month, one month, or the like, and the predetermined period of time is, for example, six months, one year, or the like. The unit period of time and the predetermined period of time can be set as desired.

When the user operates communication terminal 200 to select a recommended vehicle, a reference rate which is a rate of a reference of a metered fee rate of EV car sharing or a first rate which is a rate of a lower price than the reference rate is set as the metered fee rate. Whether the reference rate or the first rate is set as the metered fee rate is determined based on whether an SOC which vehicle 300 has when using it ends (hereinafter also referred to as a “returned SOC”) is within a recommended range. If vehicle 300 is returned with an SOC within the recommended range, the first rate is set as the metered fee rate, whereas if vehicle 300 is returned with an SOC outside the recommended range, the reference rate is set as the metered fee rate. Note that the returned SOC corresponds in the present disclosure to an “end amount of power.”

Thus, when the user selects a recommended vehicle, the metered fee rate is set to the reference rate or the first rate depending on the returned SOC of vehicle 300. By selecting a recommended vehicle, there is a possibility that a utilization fee may be set to a lower price than a reference fee. When vehicle 300 is returned with an SOC falling within the recommended range and equal to or larger than a reference value, the first rate is set as the metered fee rate. That is, when vehicle 300 departs and is returned with SOCs, respectively, falling within the recommended range, the first rate is set as the metered fee rate. This promotes utilization of vehicle 300 within the recommended range and suppresses degradation of the power storage device. In addition, returning a vehicle with an amount of power equal to or larger than the reference value stored therein is promoted and the returned vehicle is immediately available to a next user, which enhances efficiency of utilization of EV car sharing.

In the first embodiment, an example will be described in which the recommended range of SOC is 30% to 70%.

Vehicle Information List 500

FIG. 4 is a diagram showing an example of a configuration of vehicle information list 500 stored in fee setting device 100 according to the first embodiment. As shown in FIG. 4, in the first embodiment, vehicle information list 500 has a “current SOC” and an “estimated SOC for each time zone” registered therein for each vehicle identified by “vehicle information.”

The vehicle information is information for identifying vehicle 300, and it is, for example, a vehicular body number, an identification number individually assigned by an EV car sharing business operator, and the like. In the first embodiment, identification numbers such as vehicle information 300A and vehicle information 300B are assigned as the vehicle information.

As a current SOC, a current SOC obtained from each vehicle is registered. As has been described above, fee setting device 100 periodically obtains information of SOC from vehicle 300 and registers the obtained information of SOC as a current SOC in vehicle information list 500.

An estimated SOC for each time zone is obtained as follows: time is divided into 1-hour zones and an estimated SOC is calculated for each time zone and registered. An estimated SOC is an SOC estimated for each time zone from a current SOC as a vehicle is electrically charged after it is returned. For example, a vehicle with vehicle information 300A currently has an SOC of 40%, and has an SOC of 50% for a time zone from 0 to 1 o'clock and an SOC of 60% for a time zone from 1 to 2 o'clock. A vehicle with vehicle information 300B currently has an SOC of 80%, and has an SOC of 90% for the time zone from 0 to 1 o'clock and an SOC of 100% for the time zone from 1 to 2 o'clock. In the first embodiment, in order to simplify explanation, it is assumed that all vehicles have the same storage capacity and when they are electrically charged they have an SOC increased by 10% every hour.

Further, a vehicle with vehicle information 300C currently has an SOC of 50%, and has “−” registered for the time zone from 0 to 1 o'clock and the time zone from 1 to 2 o'clock. This means that the vehicle with vehicle information 300C is currently used by another user and thus has no estimated SOC calculated.

For example, vehicle information list 500 may be updated whenever fee setting device 100 obtains information of SOC from vehicle 300, or may be updated at predetermined time intervals.

While vehicle information list 500 according to the first embodiment is divided to have time zones each of one hour, the list is not limited as such. For example, the list may be divided to have time zones each of two hours or may be divided to have time zones each of 30 minutes. Alternatively, there may be no time zone provided and an estimated SOC for any time may instead be calculated.

Display List 270 of Communication Terminal

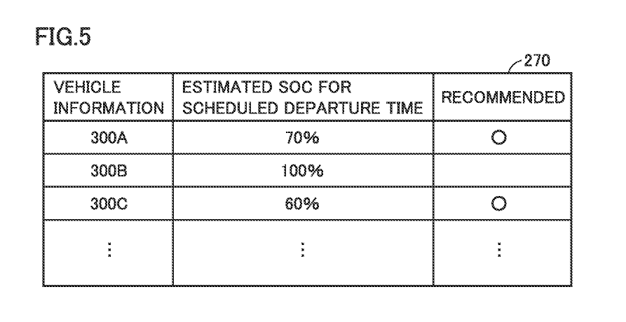

FIG. 5 is a diagram showing an example of display list 270 displayed by communication terminal 200 according to the first embodiment. As shown in FIG. 5, display list 270 displays “vehicle information,” “estimated SOC for scheduled time,” and “recommended” indicating whether a vehicle is a recommended vehicle or not.

In the “recommended” column, “◯” is registered in a field for a vehicle set as a recommended vehicle. A field for a vehicle which is not set as a recommended vehicle is left blank.

When a user uses communication terminal 200 to communicate with management device 50 to make a reservation for a vehicle, reservation information input by the user is transmitted from management device 50 to fee setting device 100. Fee setting device 100 determines vehicles reservable for a scheduled departure time included in the reservation information, and sets a recommended vehicle among the reservable vehicles. Upon setting a recommended vehicle, fee setting device 100 transmits to communication terminal 200 vehicle information of vehicles reservable for the scheduled departure time, information of SOCs of the vehicles reservable for the scheduled departure time that are estimated for the scheduled departure time, and information of whether any of the vehicles reservable for the scheduled departure time is a recommended vehicle (hereinafter collectively also referred to as “recommendation information and the like”). Communication terminal 200 displays display list 270 on display 250 using the obtained recommendation information and the like. Note that fee setting device 100 may transmit the recommendation information and the like to communication terminal 200 via management device 50.

Specifically, fee setting device 100 refers to each vehicle's reservation status information (not shown) stored in storage unit 120 to determine a vehicle reservable for a scheduled departure time. Fee setting device 100 refers to vehicle information list 500 read from storage unit 120 to obtain an SOC of the reservable vehicle estimated for the scheduled departure time. Fee setting device 100 determines whether the estimated SOC obtained falls within the recommended range, and if so, sets the vehicle as a recommended vehicle. Fee setting device 100 transmits to communication terminal 200 the vehicle information of reservable vehicles, the information of SOCs of the reservable vehicles that are estimated for the scheduled departure time, and the information of whether any of the vehicles is a recommended vehicle. Fee setting device 100 obtains reservation status information of each vehicle from management device 50 periodically and stores it to storage unit 120. Further, fee setting device 100 may obtain the reservation status information together with the reservation information from management device 50.

As an example, the vehicle with vehicle information 300A has for the scheduled departure time an estimated SOC of 70%, which falls within the recommended range.

Accordingly, “◯” is registered in the “recommended” column.

Fee List 550

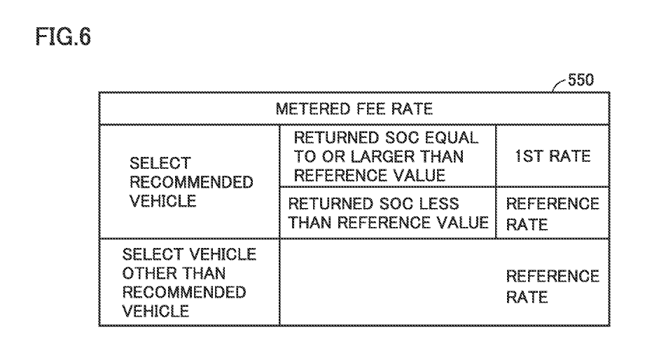

FIG. 6 is a diagram showing an example of a configuration of fee list 550 stored in fee setting device 100 according to the first embodiment. As shown in FIG. 6, in the first embodiment, fee list 550 shows whether a recommended vehicle is selected or not, and a metered fee rate depending on a returned SOC.

In the first embodiment, whether a returned SOC is equal to or larger than a reference value, which is a value within the recommended range, is determined. As the reference value, an SOC is set which is a value within the recommended range that can suppress degradation of the power storage device and which is of an extent allowing a returned vehicle to be immediately used by a next user. In the first embodiment, as an example, the reference value is set to 40%.

If a user selects a recommended vehicle and returns it with an SOC equal to or larger than the reference value, the first rate, which is a rate of a lower price than the reference fee, is set as the metered fee rate. If the user selects a recommended vehicle and returns it with an SOC less than the reference value, the reference rate is set as the metered fee rate. If the user does not select a recommended vehicle, the reference rate is set as the metered fee rate.

User List 700

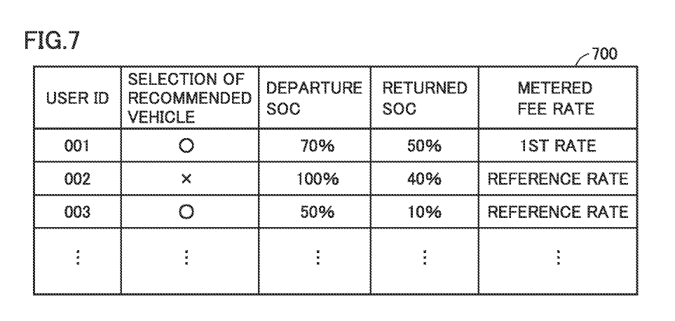

FIG. 7 is a diagram showing an example of a configuration of user list 700 stored in fee setting device 100 according to the first embodiment. As shown in FIG. 7, in the first embodiment, in user list 700, “selection of recommended vehicle,” “departure SOC,” “returned SOC,” and “metered fee rate” are registered for each user ID.

Once a user has completed registration for utilizing EV car sharing, a user ID is set for the user by management device 50 and used to identify the user. Fee setting device 100 obtains the user ID from management device 50 and registers it in user list 700.

In the “selection of recommended vehicle” column, “◯” is registered for a user who selects a recommended vehicle, and “×” is registered for a user who selects a vehicle other than a recommended vehicle.

In the “departure SOC” column, an SOC of a vehicle when utilizing the vehicle is started is registered. In the “returned SOC” column, an SOC of the vehicle when the vehicle is returned is registered.

In the “metered fee rate” column, a metered fee rate set by comparing a returned SOC with fee list 550 is registered.

As an example, a user with a user ID: 001 selects a recommended vehicle, and returns it with an SOC of 50%. The returned SOC is equal to or larger than the reference value, and when the returned SOC is compared with fee list 550, the first rate is set as the metered fee rate and registered in user list 700.

Method for Setting Utilization Fee

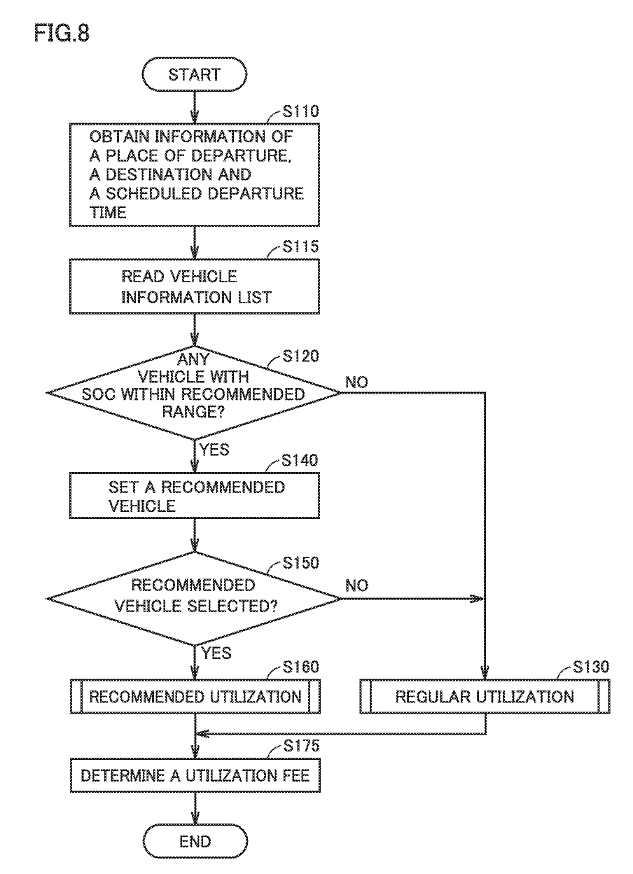

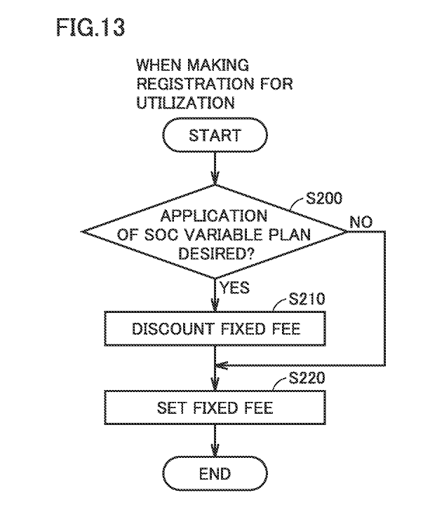

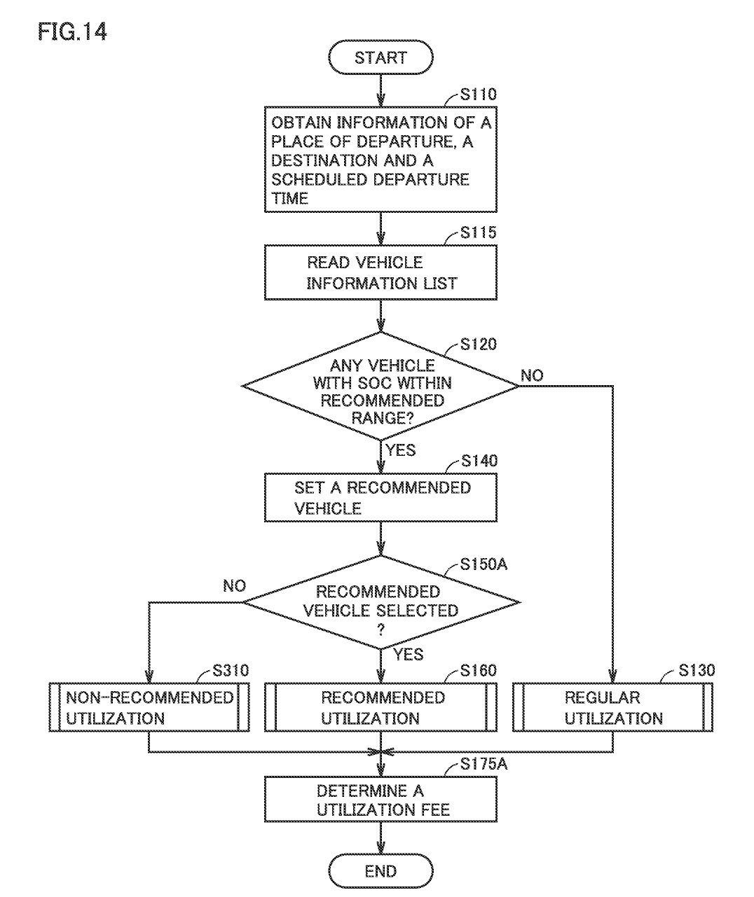

FIG. 8 is a flowchart showing a process performed by fee setting device 100 according to the first embodiment. This process is performed in sharing system 1 whenever a user utilizes EV car sharing. While each step shown in the flowchart shown in FIG. 8 is implemented by software processing done by fee setting device 100, a part thereof may be implemented by hardware (or electric circuitry) fabricated in fee setting device 100. Each step shown in the flowcharts shown in FIGS. 13 and 14 is similarly discussed.

Controller 130 obtains from management device 50 information of a place of departure, a destination and a scheduled departure time input by a user via communication terminal 200 (reservation information) (step (hereinafter indicated as “S”) 110). Controller 130 reads vehicle information list 500 from storage unit 120 (S115).

Controller 130 determines whether any of vehicles reservable for the scheduled departure time obtained in S110 has an estimated SOC falling within the recommended range for the scheduled departure time (S120).

If controller 130 determines that there is any vehicle with an estimated SOC falling within the recommended range for the scheduled departure time (YES in S120), controller 130 sets the vehicle as a recommended vehicle (S140).

When the user selects the recommended vehicle (YES in S150), controller 130 selects recommended utilization and performs a process described hereinafter (S160). Recommended utilization is utilization of EV car sharing using a recommended vehicle set by controller 130.

If controller 130 determines in S120 that there is no vehicle with an estimated SOC falling within the recommended range for the scheduled departure time (NO in S120), and if the recommended vehicle is not selected in S150 (NO in S150), controller 130 selects regular utilization and performs a process described hereinafter (S130). Regular utilization is utilization of EV car sharing using a vehicle when no recommended vehicle is set by controller 130. Specifically, it is selected when controller 130 determines in S120 that there is no vehicle with an estimated SOC falling within the recommended range for the scheduled departure time (NO in S120). In the first embodiment, regular utilization also includes utilization of EV car sharing using a vehicle other than a vehicle although the latter is set as a recommended vehicle by controller 130.

Controller 130 performs a process for regular utilization (S130) or recommended utilization (S160), which will be described hereinafter, and sets a utilization fee depending on a product of a set metered fee rate and an amount of power used (S175).

Regular Utilization

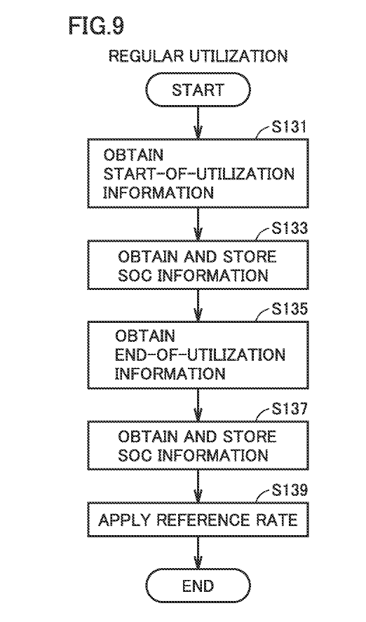

FIG. 9 is a flowchart showing a process performed by fee setting device 100 according to the first embodiment for regular utilization.

When controller 130 receives from vehicle 300 start-of-utilization information indicating that utilization of vehicle 300 has been started (S131), controller 130 obtains from vehicle 300 SOC information at the time when the utilization is started, and controller 130 registers it in user list 700 as a departure SOC (S133).

When controller 130 receives end-of-utilization information indicating that utilization of vehicle 300 has ended (S135), controller 130 obtains SOC information from vehicle 300 and registers it in user list 700 as a returned SOC (S137).

Controller 130 applies the reference rate to the metered fee rate and registers it in user list 700 (S139).

Recommended Utilization

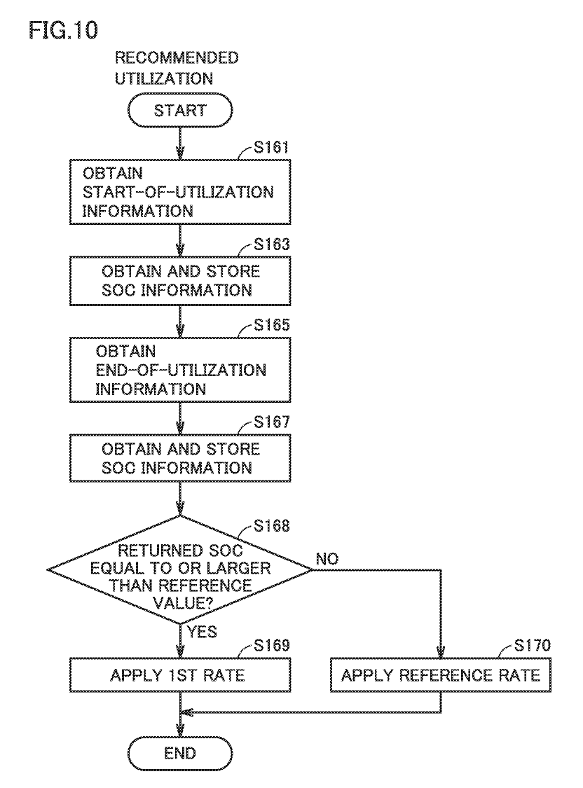

FIG. 10 is a flowchart showing a process performed by fee setting device 100 according to the first embodiment for recommended utilization. Note that steps S161 to S167 are respectively similar to S131 to S137 in the above-described regular utilization, and accordingly, will not be described repeatedly.

Controller 130 determines whether the returned SOC obtained in S167 is equal to or larger than the reference value (S168). When controller 130 determines that the returned SOC is equal to or larger than the reference value (YES in S168), controller 130 applies the first rate to the metered fee rate and registers it in user list 700 (S169). When controller 130 determines that the returned SOC is less than the reference value (NO in S168), controller 130 applies the reference rate to the metered fee rate and registers it in user list 700 (S169).

Thus, in the first embodiment, fee setting device 100 selects from vehicles reservable for a scheduled departure time reserved via communication terminal 200 a vehicle having an estimated SOC falling within the recommended range for the scheduled departure time and sets the vehicle as a recommended vehicle. Then, fee setting device 100 transmits information of reservable vehicles, information of the recommended vehicle, and the like and to communication terminal 200, and causes communication terminal 200 to display them.

This allows a user to clearly recognize a vehicle of reservable vehicles that is recommended, and can increase the possibility that the user selects the recommended vehicle.

When the user operates communication terminal 200 to select the recommended vehicle, the reference rate or the first rate is set as the metered fee rate. Whether the reference rate is set as the metered fee rate or the first rate is set as the metered fee rate is determined based on whether vehicle 300 is returned with an SOC falling within the recommended range. If vehicle 300 is returned with an SOC falling within the recommended range, the first rate is set as the metered fee rate, whereas if vehicle 300 is returned with an SOC outside the recommended range, the reference rate is set as the metered fee rate.

Thus when the user selects the recommended vehicle, the metered fee rate is set to the reference rate or the first rate depending on how vehicle 300 is used. By selecting the recommended vehicle, there is a possibility that a utilization fee may be set to a lower price than a reference fee. When vehicle 300 departs with an SOC falling within the recommended range and is returned with an SOC falling within the recommended range and also equal to or larger than a reference value, the first rate is set as the metered fee rate. This promotes utilization of vehicle 300 within the recommended range and suppresses degradation of the power storage device. In addition, returning a vehicle with an amount of power equal to or larger than the reference value stored therein is promoted, and the returned vehicle is immediately available to a next user, which enhances efficiency of utilization of EV car sharing.

In the first embodiment, a metered fee rate for setting a metered fee is set depending on whether vehicle 300 selected is a recommended vehicle or whether vehicle 300 is returned with an SOC equal to or larger than a reference value. What is set depending on whether vehicle 300 selected is a recommended vehicle or whether vehicle 300 is returned with an SOC equal to or larger than the reference value is not limited to the metered fee and may be a fixed fee.

In the first embodiment, a reference value which is a value within a recommended range is used as a reference for determining a returned SOC. This reference value may be set within the recommended range, as desired.

### Second Embodiment

While sharing system 1 of EV car sharing according to the first embodiment is applied to a user who makes registration for utilizing EV car sharing, it may for example be a form in which when making registration for utilizing EV car sharing the user can select a plurality of plans. For example, it may be a form allowing the user to make selection between a plan with a metered fee rate varying with the SOC of vehicle 300, as done in sharing system 1 according to the first embodiment (hereinafter also referred to as an “SOC variable plan”), and a regular plan allowing utilization with a fixed fee rate irrespective of the SOC of vehicle 300 or the like. In the second embodiment, an example will be described in which a user can select the SOC variable plan and the regular plan when the user makes registration for utilization of EV car sharing. The SOC variable plan corresponds in the present disclosure to a “recommended plan.”

A sharing system according to the second embodiment is similar in configuration to sharing system 1 according to the first embodiment, and accordingly, will not be described repeatedly. Vehicle information list 500 and display list 270 of the communication terminal are also similar to those according to the first embodiment, and accordingly, will not be described repeatedly.

In the EV car sharing in the second embodiment, as well as the EV car sharing in the first embodiment, a user who has made registration as a user of EV car sharing is charged for each unit period of time a utilization fee charged for that unit period of time. For the utilization fee, a fixed fee and a metered fee are set.

In the second embodiment, when a user makes registration for utilization of EV car sharing, management device 50 urges the user to select the SOC variable plan or the regular plan. Fee setting device 100 obtains from management device 50 information indicating a plan selected by the user. When the SOC variable plan is selected, fee setting device 100 sets a fixed fee of a lower price than when the regular plan is selected. This promotes selection of the SOC variable plan.

The metered fee applied when the regular plan is selected is calculated by a product of an amount of power used as a vehicle is utilized and a reference rate, regardless of whether a recommended vehicle may be selected or not. When the SOC variable plan is selected, and a recommended vehicle is selected, then, similarly as done in the first embodiment, the metered fee rate is determined depending on whether the vehicle is returned with an SOC equal to or larger than the reference value. If the returned SOC is equal to or larger than the reference value, the first rate is applied as the metered fee rate, whereas if the returned SOC is less than the reference value, the reference rate is applied as the metered fee rate. If the recommended vehicle is not selected, a second rate of a higher price than the reference rate is applied as the metered fee rate.

Accordingly, when the SOC variable plan is selected, and a vehicle other than a recommended vehicle is used, the second rate of a higher price than the reference rate is applied, which promotes utilization of the recommended vehicle. Further, when the recommended vehicle is used, and the vehicle is returned with an SOC in a state equal to or larger than the reference value, the first rate of a lower price than the reference rate is applied, which promotes returning the vehicle with an SOC equal to or larger than the reference value. This promotes utilizing a vehicle with an SOC within a recommended range that can suppress degradation of the power storage device.

Fee List 550A

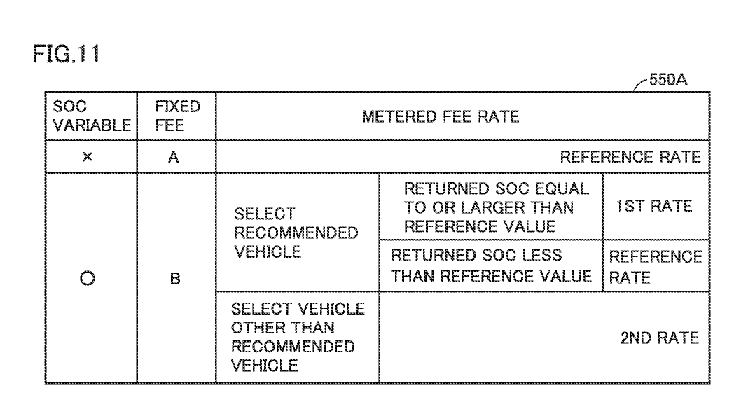

FIG. 11 is a diagram showing an example of a configuration of a fee list 550A stored in fee setting device 100 according to the second embodiment. As shown in FIG. 11, in fee list 550A, “SOC variable,” “fixed fee,” and “metered fee rate” are registered.

“SOC variable” indicates whether the SOC variable plan is applied. “×” indicates a case where the SOC variable plan is not applied (or the regular plan is applied), and “◯” indicates a case where the SOC variable plan is applied.

When the SOC variable plan is not applied, the fixed fee is set to a fixed fee A, and the metered fee rate is set to the reference rate.

When the SOC variable plan is applied, the fixed fee is set to a fixed fee B, which is of a lower price than fixed fee A. For the metered fee rate, the first rate is set when a recommended vehicle is selected and the vehicle is returned with an SOC equal to or larger than the reference value. For the metered fee rate, the reference rate is set when a recommended vehicle is selected and the vehicle is returned with an SOC less than the reference value. For the metered fee rate, the second rate is set when a vehicle other than a recommended vehicle is selected.

User List 700A

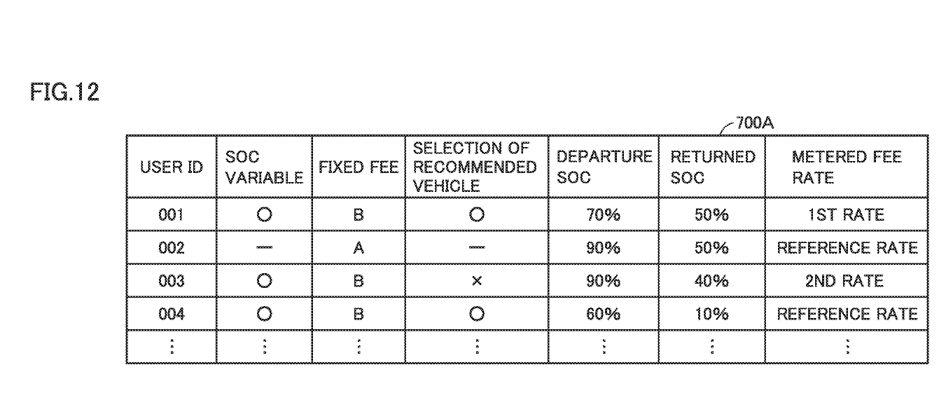

FIG. 12 is a diagram showing an example of a configuration of a user list 700A stored in fee setting device 100 according to the second embodiment. As shown in FIG. 12, in the second embodiment, in user list 700A, “SOC variable,” “fixed fee,” “selection of recommended vehicle,” “departure SOC,” “returned SOC,” and “metered fee rate” are registered for each user ID.

When a user completes registration for utilization of EV car sharing, a user ID is set by management device 50 for that user, and used to identify the user. Fee setting device 100 obtains the user ID from management device 50 and registers it in user list 700A.

For “SOC variable,” “◯” or “×” is registered depending on a selection made by a user when the user makes registration for utilization of EV car sharing. Specifically, “◯” is registered when the user selects the SOC variable plan, and “×” is registered when the user selects the regular plan.

The fixed fee is set by comparing the registered information in the “SOC variable” column with fee list 550A. Specifically, if the SOC variable is “×”, fixed fee A is registered with reference to fee list 550A. If the SOC variable is “◯”, fixed fee B is registered with reference to fee list 550A.

In the “selection of recommended vehicle” column, “◯” is registered for a user who selects a recommended vehicle, and “×” is registered for a user who selects a vehicle other than a recommended vehicle.

In the “departure SOC” column, an SOC which a vehicle has when utilizing the vehicle is started is registered. In the “returned SOC” column, an SOC which the vehicle has when the vehicle is returned is registered.

In the “metered fee rate” column, a metered fee rate set by comparing a returned SOC with fee list 550A is registered. Details will be described later.

Method for Setting Utilization Fee

FIG. 13 is a flowchart showing a process performed by fee setting device 100 according to the second embodiment for setting a fixed fee. This process is performed in sharing system 1 when a user makes registration for utilizing EV car sharing.

Controller 130 obtains from management device 50 information input by a user via communication terminal 200, and determines which of the regular plan and the SOC variable plan has been selected by the user (S200). When controller 130 determines that the regular plan has been selected (NO in S200), controller 130 refers to fee list 550 and sets fixed fee A (S220).

When controller 130 determines that the SOC variable plan has been selected (YES in S200), controller 130 registers “◯” in user list 700A at the “SOC variable” column and sets application of the SOC variable plan (S210). Then, controller 130 refers to fee list 550 and sets fixed fee B (S220).

Method for Setting Metered Fee

FIG. 14 is a flowchart showing a process performed by fee setting device 100 according to the second embodiment for setting a metered fee. This process is performed in sharing system 1 whenever a user utilizes EV car sharing. The process in FIG. 14 is the same as the process in FIG. 8 according to the first embodiment except for a process performed in a case where a recommended vehicle is not selected in S150. Accordingly, in the following description, the process in FIG. 14 will not be described repeatedly except for steps different than the process in FIG. 8, i.e., S150A, S175A, S310. Note that in the second embodiment, regular utilization means utilization of EV car sharing using a vehicle when no recommended vehicle is set by controller 130.

In S150A, if the user does not select a recommended vehicle (NO in S150A), controller 130 selects non-recommended utilization and performs a process described hereinafter (S310). Non-recommended utilization means utilization of EV car sharing using a vehicle other than a vehicle although the latter is set as a recommended vehicle by controller 130.

Controller 130 performs the process of one of regular utilization (S130), recommended utilization (S160) and non-recommended utilization (S310), and sets a utilization fee by a product of a set metered fee rate and an amount of power used (S175).

Non-Recommended Utilization

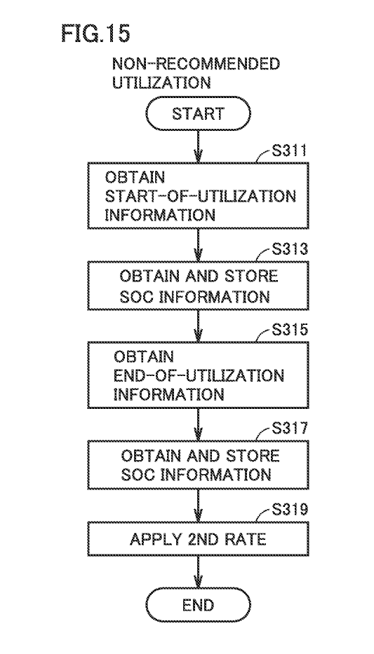

FIG. 15 is a flowchart showing a process performed by fee setting device 100 according to the second embodiment for non-recommended utilization.

When controller 130 receives from vehicle 300 start-of-utilization information indicating that utilization of vehicle 300 has been started (S311), controller 130 reads from vehicle 300 information of an SOC which vehicle 300 has when the utilization thereof is started (i.e., a departure SOC), and controller 130 registers it in user list 700A as a departure SOC (S313).

When controller 130 obtains end-of-utilization information indicating that utilization of vehicle 300 has ended (S315), controller 130 reads SOC information from vehicle 300 and registers it in user list 700A as a returned SOC (S317).

Controller 130 applies the second rate to the metered fee rate and registers it in user list 700A (S319).

### EXAMPLES

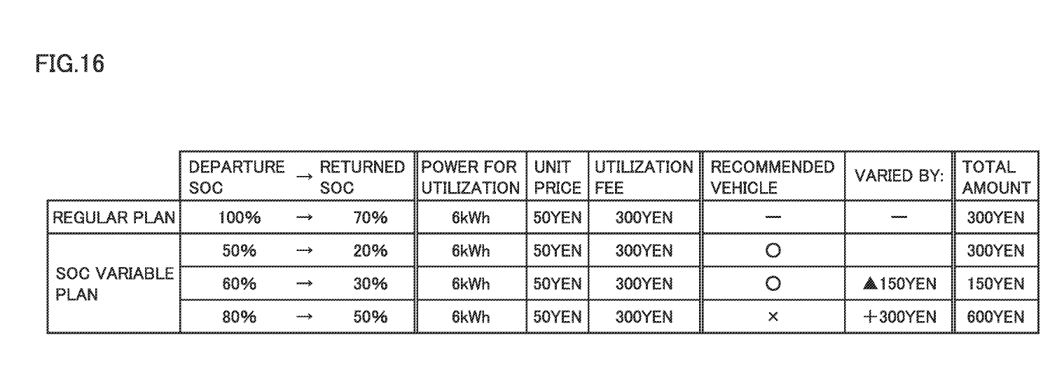

Hereinafter, the second embodiment will be described using an example. FIG. 16 is a diagram for illustrating an example with the configuration of the second embodiment applied thereto. In the following description, in order to simplify explanation, it is assumed that all vehicles have mounted therein power storage devices, respectively, of substantially the same power storage capacity and substantially the same state of degradation. Furthermore, it is assumed that power for utilization that is required to travel from a place of departure to a destination is uniformly 6 kWh and a unit price of power serving as the reference rate is 50 yen. It is assumed that a unit price of power serving as the first rate is 25 yen, and that serving as the second rate is 100 yen. Furthermore, it is assumed that the recommended range is set to an SOC of 30% to 70%, and the reference value is set to an SOC of 40%.

For the regular plan, the power for utilization is 6 kWh and the unit price of power is 50 yen, and accordingly, the utilization fee will be 300 yen.

For the SOC variable plan, in a case with a departure SOC of 50% and a returned SOC of 20%, a recommended vehicle is selected because the departure SOC is 50%. However, as the returned SOC is 20%, the reference rate is set as the metered fee rate. As the power for utilization is 6 kWh, and the unit price of power is 50 yen, the utilization fee will be 300 yen.

For the SOC variable plan, in a case with a departure SOC of 70% and a returned SOC of 40%, a recommended vehicle is selected because the departure SOC is 70%. As the returned SOC is 40%, the first rate is set as the metered fee rate. As the power for utilization is 6 kWh, and the unit price of power is 25 yen, the utilization fee will be 150 yen.

For the SOC variable plan, in a case with a departure SOC of 80% and a returned SOC of 50%, a vehicle other than a recommended vehicle is selected because the departure SOC is 80%. Accordingly, the second rate is set as the metered fee rate. As the power for utilization is 6 kWh, and the unit price of power is 100 yen, the utilization fee will be 600 yen.

Thus, in the second embodiment, when the SOC variable plan is selected, the fixed fee is set to a lower price than when the regular plan is selected. When the SOC variable plan is selected, and vehicle 300 is utilized with an SOC falling within a recommended range that can suppress degradation of the power storage device, the metered fee is also set to a lower price than the regular plan.

On the other hand, when the SOC variable plan is selected and there is a recommended vehicle, and despite that, the recommended vehicle is not selected, a metered fee of a higher price than the regular plan is set.

By thus selecting the SOC variable plan, a fixed fee is set to a lower price than when the regular plan is selected, and selection of the SOC variable plan is thus promoted, and by a scheme of setting a metered fee, utilization of a vehicle within a recommended range is promoted. In other words, utilization of an electric vehicle in car sharing can be promoted without premature degradation of an electric storage device mounted in the electric vehicle.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A fee setting device configured to set a utilization fee for sharing an electric vehicle, comprising:
an information acquisition unit configured to obtain, from a vehicle utilized for the sharing, information of an amount of power stored in a power storage device mounted in the vehicle;
a vehicle setting unit configured to set as a recommended vehicle a vehicle with a power storage device having an amount of power stored therein within a predetermined range when the vehicle is rented, and recommend the vehicle to a user; and
a fee setting unit configured to set the utilization fee,
the amount of power stored in the power storage device when the vehicle is rented being estimated from the amount of power stored in the power storage device that is obtained by the information acquisition unit,
the fee setting unit being configured to set the utilization fee at a lower price than a reference fee of the utilization fee when the recommended vehicle is utilized and an end amount of power falls within the predetermined range, the end amount of power being an amount of power stored in the power storage device when the vehicle is returned.

2. The fee setting device according to claim 1, wherein the fee setting unit sets the reference fee as the utilization fee when the recommended vehicle is utilized and the end amount of power is outside the predetermined range.

3. The fee setting device according to claim 1, wherein the fee setting unit sets the utilization fee at a lower price than the reference fee when the recommended vehicle is utilized and the end amount of power stored in the power storage device of the recommended vehicle falls within the predetermined range and is also equal to or larger than a reference value within the predetermined range.

4. The fee setting device according to claim 1, wherein the fee setting unit sets the utilization fee at a higher price than the reference fee when a vehicle with a power storage device having stored therein an amount of power larger than the recommended vehicle is utilized.

5. The fee setting device according to claim 1, wherein
the utilization fee includes a fixed-fee portion in which a fee per unit period of time is fixed, and a metered-fee portion in which a fee varies with an amount of power used as the vehicle is utilized, and
the fee setting unit sets the fixed-fee portion at a lower price when a recommended plan is applied than when the recommended plan is not applied, the recommended plan setting a unit price of power of the metered-fee portion based on the amount of power stored in the power storage device.

6. A fee setting method for setting a utilization fee for sharing an electric vehicle, comprising:
obtaining, from a vehicle used for the sharing, information of an amount of power stored in a power storage device mounted in the vehicle;
setting as a recommended vehicle a vehicle with a power storage device having an amount of power stored therein within a predetermined range when the vehicle is rented, and recommending the vehicle to a user;
setting the utilization fee; and
estimating the amount of power stored in the power storage device when the vehicle is rented from the obtained amount of power stored in the power storage device,
the setting the utilization fee including setting the utilization fee at a lower price than a reference fee of the utilization fee when the recommended vehicle is utilized and an end amount of power falls within the predetermined range, the end amount of power being an amount of power stored in the power storage device when the vehicle is returned.
